(19) United States
(12) Patent Application Publication
(10) Pub. No.: US 2020/0124036 A1
(43) Pub. Date: Apr. 23, 2020

(54) OIL-FREE VACUUM PUMP HAVING A PRISMATIC PISTON AND CORRESPONDING COMPRESSOR

(71) Applicant: NIDEC GPM GMBH, Auengrund OT Merbelsrod (DE)

(72) Inventors: Franz PAWELLEK, Lautertal (DE); Conrad NICKEL, Troistedt (DE)

(73) Assignee: NIDEC GPM GMBH, Auengrund OT Merbelsrod (DE)

(21) Appl. No.: 16/477,607

(22) PCT Filed: Dec. 11, 2017
(86) PCT No.: PCT/EP2017/082202

§ 371 Date: Jul. 12, 2019

(30) Foreign Application Priority Data
Feb. 7, 2017 (DE) 10 2017 102 324.0

(51) Int. Cl. F04B 37/14; F04B 9/04; F04B 35/04; F04B 39/00

(52) U.S. Cl. CPC F04B 37/14; F04B 9/047; F05B 2210/12; F04B 39/0016; F04B 35/04

(57) ABSTRACT

The invention relates to an oil-free vacuum pump for evacuating gaseous media, comprising: an electric motor which drives a shaft; a pump housing having a pump chamber, as well as an inlet and an outlet; a prismatic displacement piston which is accommodated in the pump chamber such that it is bidirectionally active and can be moved on a reciprocal working section; and at least one pressure valve which releases an outflow of a gaseous medium out of the pump chamber through the outlet and blocks an inflow into the pump chamber. The displacement piston has a slot into which a drive force of the shaft is introduced via a crankpin by means of a rolling bearing.

The present invention relates to an oil-free vacuum pump having a prismatic piston and a similar device for use as an oil-free compressor.

Vacuum pumps are used in numerous application fields of pneumatics in processes engineering or in vehicle construction. In the automotive field they are necessary, for example, in order to adjust exhaust flaps, guide vanes of variable nozzle turbochargers, or a bypass in order to adjust the boost pressure with a wastegate. They can also be used to actuate a central locking system or headlight flaps.

The function of evacuating brake boosters in order to increase a force applied by the driver to the brake system at a brake pedal is particularly important. In order to achieve the boost effect, a vacuum chamber of a brake booster is continually evacuated when the vehicle is started and while driving. For this reason, there is an increased demand with regard to reliability and longevity of the vacuum pump in this application for operating a brake system of a vehicle.

In addition, the packaging in the engine compartment of a modern vehicle with numerous auxiliaries provides only very limited installation space for the vacuum pump. The vacuum pump is furthermore subjected to high temperature fluctuations in this application.

In vehicle construction, circumferential displacement pumps are primarily used, for example vane pumps or rotary vane pumps. Vane pumps made of metal materials require a lubricating film to be provided between the rotating and the stationary parts of the pump in order to ensure sufficient, gas-tight sealing, as well as low frictional wear at the contact surfaces. Therefore, a supply of lubricant or an integration into a circuit of a system carrying lubricant must be provided by the vehicle for such vane pumps.

In addition to this restriction with regard to the construction, the requirement of a lubricating film in a vacuum pump furthermore raises a problem with regard to the temperature-dependent viscosity of the lubricant and the contamination through the absorption of particles from the diverted air. These disadvantages are relevant in the fluctuating environmental conditions of a mobile application and particularly, to a greater extent, if the pump is installed in an engine compartment of a vehicle. Previously, vehicle manufacturers had to recall models because, due to an insufficient lubricant supply of such vacuum pumps, there was a risk of the brake booster failing under unfavourable circumstances.

In addition, vane pumps with mating surfaces of carbon materials capable of dry-running are known, which are used in the aviation industry, for example. In addition to the cost-intensive materials, such pumps have the disadvantages of high friction losses and a high noise level.

Oil-free vacuum pumps that offer advantages in terms of low maintenance requirements while going without regular lubrication of drive elements or which supply gasses that may not be contaminated by traces of lubrication oil are also required in other fields of process technology besides automotive applications.

In addition to circumferential displacement pumps, double-acting displacement pumps with oscillating members which can manage with little lubricant at low friction coefficients are known in process technology. A prismatic shape instead of a cylindrical shape of the piston has shown itself to be advantageous, whereby a lower point load at a piston sliding surface is achieved due to an improved surface distribution of transverse forces or tilting moments.

To date, such pumps with prismatic pistons have been used in stationary applications. Accordingly, the forms known from the state of the art typically have relatively large dimensions and a disadvantageous design that is not suitable for being installed in a vehicle or any other mobile applications.

A compact embodiment of such a vacuum pump having a prismatic piston is described in U.S. Pat. No. 5,556,267 B. In addition to the compact construction of the pump assembly, which is shown without a drive, high volumetric efficiency and low manufacturing expenditure are cited as advantages.

The described double-acting pump is driven via an eccentric cam rotating in a sliding block that in turn reciprocates in a multi-part piston. The sliding block feature generally allows the conclusion that the drive cannot be operated without a lubrication oil between the piston, the sliding block and the eccentric cam. Furthermore, the piston is assembled of several fits and parts, the sum of which complicate a realization of narrow running clearances inside the cylinder sliding surface and increase manufacturing complexity.

Therefore, one object of the present invention is to provide a vacuum pump having a simple, economic construction which may be operated without oil.

This object is achieved according to the present invention by an oil-free vacuum pump for evacuating gaseous mediums having the features of claim 1.

Said oil-free vacuum pump comprises an electric motor driving a shaft; a pump housing having a pump chamber as well as an inlet and an outlet; a prismatic displacement piston that, acting bi-directionally and movable over a reciprocal operating path, is accommodated within the pump chamber, the displacement piston releasing a connection between the inlet and the pump chamber in the region of two dead centres of the reciprocal operating path and overlapping in a region lying in between; and at least one pressure valve that releases a flow of gaseous medium out of the pump chamber through the outlet and blocks a flow into the pump chamber.

The oil-free vacuum pump according to the present invention is particularly characterized by the fact that the displacement piston comprises an elongated hole into which a driving force of the shaft is introduced via a crankpin by means of a roller bearing. The invention therefore provides, for the first time, a vacuum pump with a scotch yoke mechanism as drive kinematics, operable without oil, for a prismatic displacement piston operating efficiently according to the double stroke principle or compressing bi-directionally.

Due to the rolling friction absorbed by the roller bearing on the crankpin in the elongated hole, a high friction portion can be avoided compared to drive kinematics of the prior art.

Due to the prismatic or rectangular shape, the piston is guided along the path of the pump chamber with low lateral forces. Furthermore, long sealing gaps result along the rectangular shape.

An economic, electric, oil-free vacuum pump having few members is thus provided which realizes an excellent volumetric efficiency with low displacement friction.

The vacuum pump is based on the realization according to the invention that, due to its rolling friction, a grease-lubricated roller bearing that transfers the rotatory driving force of the crankpin via a linear engagement with the elongated hole is advantageously suitable as a transfer means that enables a permanent, low-wear drive of the piston in a power range of the vacuum pump of up to approximately 1 kW without any continuous or periodic supply of lubrication oil. Forgoing lubrication oil that leaks out at clearances of the reciprocating members as finely atomized droplets through the pump chamber and the outlet due to oscillation and turbulences offers various advantages.

The vacuum pump according to the present invention requires no maintenance intervals for lubricating the drive assembly.

If used to evacuate a brake booster or any other pneumatically driven auxiliary devices in a vehicle, the vacuum pump according to the present invention may be positioned flexibly according to the structure inside the engine compartment of a vehicle due to the omitted connection to a lubricant supply, which also leads to lower manufacturing expenditure. Furthermore, the vacuum pump according to the present invention is fail safe with respect to lubricant supply.

In contrast to similar double-stroke pump types, the vacuum pump according to the present invention may also be used in process technology applications that are sensitive to contamination.

Compared to dry-running pump types such as diaphragm pumps, the vacuum pump according to the present invention has a better performance-dimension ratio.

Compared to vane-type circumferential displacement pumps with members made of components capable of dry-running made of technical carbon materials, the vacuum pump according to the present invention generates lower frictional losses and less noise with similar dimensions or driving power.

Other advantageous further embodiments of the vacuum pump according to the present invention are the object of the dependent claims.

According to one aspect of the invention, the at least one pressure valve and at least one outlet channel, which create a connection between the pump chamber and the outlet of the pump housing for the outflow of the gaseous medium, may be arranged in the displacement piston. Regions of the construction that require a more complex moulded part to be manufactured due to channel guidance or a valve seat may therefore only be moved into the member of the displacement piston, where such a requirement already exists in order to form the elongated hole. In this way, a section of the pump housing forming our walls of the pump chamber may in turn be realized economically as a simple cast piece in the shape of a square profile.

According to one aspect of the invention, the piston may be formed integrally as one piece with the exception of the pressure valves. In this way, the manufacturing and the assembly of the member is simplified while mutual fits are omitted.

According to one aspect of the invention, two pressure valves respectively assigned to one displacement surface may be arranged in the displacement piston. When arranging a pressure valve in relation to each displacement surface, inertia torque acting on an elastically pre-stressed valve body in the pressure valve is used advantageously.

According to one aspect of the invention, an outlet pocket which faces an opening of the outlet channel within the displacement piston and of which the extension coincides with a reciprocal range of movement of the opening of the outlet channel may be formed in the pump housing in the region of the outlet. The outlet pocket coinciding with a reciprocal range of movement of the opening of the outlet channel within the displacement piston forms a simple, permanent connection between the static housing portions of the pump chamber and the outlet channel of the oscillating displacement piston.

According to one aspect of the invention, an inlet pocket which faces the displacement piston and which extends beyond positions of the displacement surfaces situated at the dead centres on the inside of the reciprocal operating path of the displacement piston may be formed in the pump housing in the region of the inlet. The inlet pocket at the dead centres of the reciprocal operating path of the displacement piston thereby forms, in a simple manner, two control slots that establish a connection from the inlet, past an edge of an inward-lying displacement surface of the displacement piston, into the pump chamber. In contrast to an inlet routing with two separate control slots, the inlet pocket provides a larger flow cross-section as well as a pre-chamber so that there is less suction throttling in the short suction phases at the dead centres and a larger intake volume may be handled. The volumetric efficiency of the vacuum pump is thus increased.

According to one aspect of the invention, the dimensions of the pump chamber and of the sliding surfaces of the prismatic displacement piston which are parallel to the reciprocal operating path, may form a gap seal. A seal with low friction and little wear is thus realized. Furthermore, the assembly is simplified by omitting seals.

According to one aspect of the invention, the dimensions may be selected such that a gap in the pump chamber surrounding the displacement piston has a size of less than 50 μm. With this size, in conjunction with the large gap lengths along the prismatic piston which are due to the construction, sufficient sealing may be achieved between the displacement chambers on either side of the piston inside the pump chamber. Furthermore, using and installing seals or piston rings may in this way be omitted.

According to one aspect of the invention, a noise dampening element may be disposed within or at the outlet. The noise level of the vacuum pump may thus be economically decreased by a flexible material having a porous structure.

According to one aspect of the invention, the crankpin may be connected to a free end of the shaft. Additional mounting in the axial region of the pump assembly may thus be avoided and smaller overall axial dimensions of the vacuum pump may thus be realized.

According to one aspect of the invention, the crankpin may be connected to the free end of the shaft by means of a rotary plate. By forming a plate-shaped connection, turbulences in the rotation region between drive assembly and pump assembly as well as an imbalance of the crankpin may be minimized.

According to one aspect of the invention, a rotor of the electric motor may be connected to a free end of the shaft. In this way, additional mounting in the axial region of the drive assembly may also be avoided, and smaller overall axial dimensions of the vacuum pump may be realized.

According to one aspect of the invention, the shaft may be mounted by means of a single shaft bearing having two rows of rolling elements. This construction further promotes achieving smaller overall axial dimensions of the vacuum pump.

According to one aspect of the invention, the electric motor may be arranged so as to axially overlap with the shaft bearing and a housing portion receiving the shaft bearing. This construction also promotes achieving smaller overall axial dimensions of the vacuum pump.

According to one aspect of the invention, the vacuum pump with the aforementioned features may also be used as an oil-free compressor. The advantage of the construction according to the present invention, the fact that no atomized lubrication oil is carried out of the outlet over a long duration, particularly offers an advantage with regard to its use where a system vulnerable to contamination is to be supplied with compressed air, such as in laboratories.

The invention is described below in detail based on one exemplary embodiment with reference to the accompanying drawings. They show:

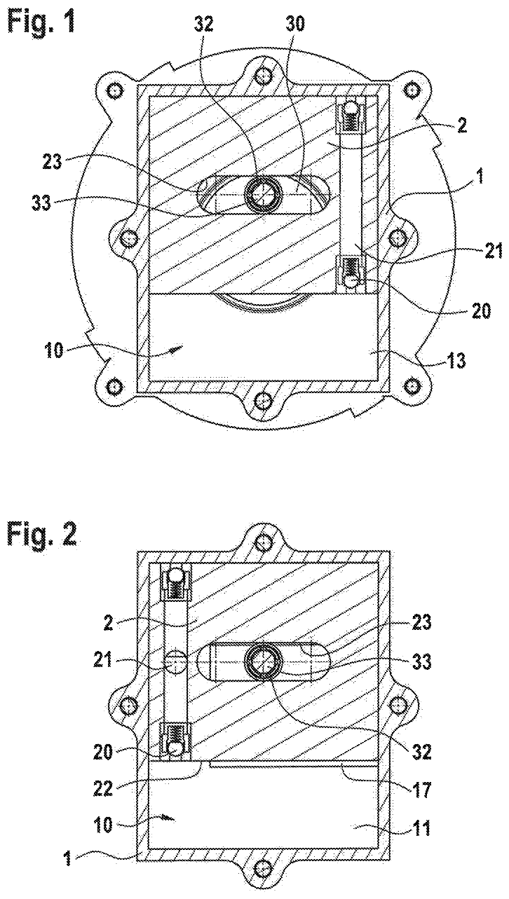

FIG. 1 a cross-sectional view of the pump housing and the displacement piston with a plan view of the electric drive;

FIG. 2 a cross-sectional view of the pump housing and the displacement piston in the opposite direction to FIG. 2;

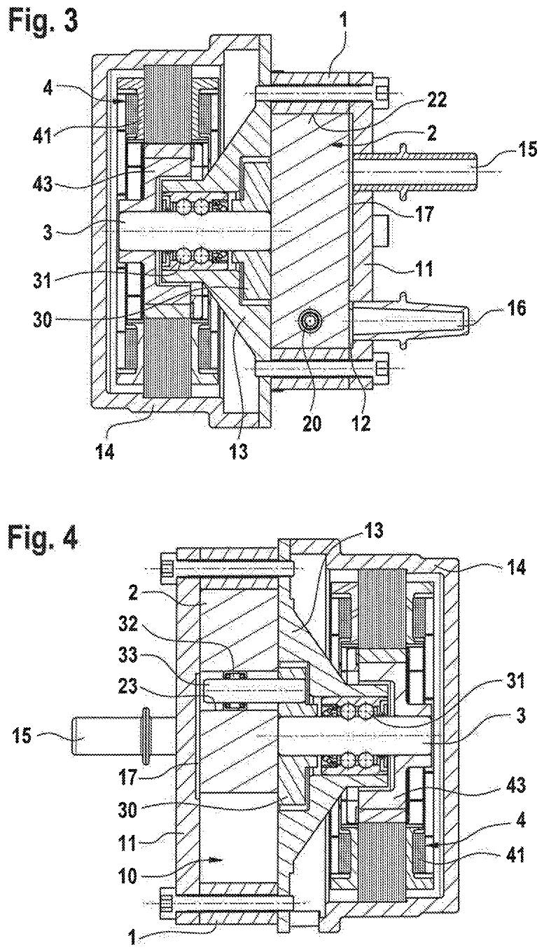

FIG. 3 a longitudinal sectional view of the inlet and the outlet with a plan view of a displacement surface of the displacement piston;

FIG. 4 a longitudinal sectional view of the crankpin and the roller bearing; and

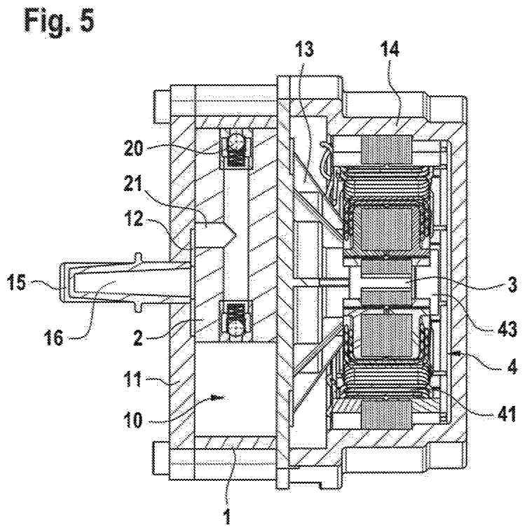

FIG. 5 a longitudinal sectional view of the outlet channel of the displacement piston and the outlet.

As FIGS. 1 and 2 show, the pump housing 1 has four walls in the cross-sectional profile which enclose a rectangular pump chamber 10. A rectangular or cuboidal displacement piston 2 that reciprocates linearly is accommodated inside the pump chamber 10 in a slideable manner. An electric drive assembly is flanged to the pump housing 1.

As shown in FIG. 3, the pump chamber 10 is closed at one side facing the drive assembly by a chamber wall 11 that essentially takes up the rectangular outline of the cross-sectional profile of the pump chamber 10. Two ducts are formed at the chamber wall 11 through which an inlet 15 and an outlet 16 open into the pump chamber 10. At a side facing the chamber wall 11, the pump chamber 10 is closed off relative to the drive assembly by a housing portion 13. The chamber wall 11, the pump housing 1 and the housing portion 13 are screwed together.

The housing portion 13 is joined to a motor housing 14 that accommodates an electric motor 4. The electric motor 4 is essentially formed by a stator 41 fixed inside the motor housing 14, and a rotor 43, rotatably arranged radially inside the stator 41, seated on a shaft 3 and driving the same.

The shaft 3 is mounted by means of a double-row shaft bearing 31, for example a water pump bearing, in a central axial portion of the shaft 3. The shaft bearing 31 is accommodated within the housing portion 13. A receiving portion of the housing portion 13 into which the shaft bearing 31 is fitted extends both radially as well as axially within the rotor 43. The rotor 43 is therefore fixed torque proof on one side of the shaft bearing 31 at a free end of the shaft 3 and an electromotively effective casing portion of the rotor 43 facing the stator 41 and including permanent magnetic elements extends both radially as well as axially beyond a part of the shaft bearing 31.

A circular carrier plate 30 is disposed torque proof on the other side of the shaft bearing 31 at the other free end of the shaft 3. At the carrier plate 30, a crankpin 33 is disposed in an axial extension of the shaft end and offset from the rotation axis of the shaft 3. The carrier plate 30 is accommodated rotatably in a corresponding, rotationally symmetric recess of the housing portion 13.

As shown in FIG. 4, a roller bearing 32 is set on the crankpin 33, via which the crankpin 33 meshes with an elongated hole 23 accommodated within the displacement piston 2. The elongated hole 23 is vertical or transverse to an operating path of the displacement piston 2 and recessed along its entire length.

Acting together with the shaft 3 including the carrier plate 30, a scotch yoke mechanism is formed via the crankpin 33 and the roller bearing 32, which mesh with the elongated hole 23; said mechanism turns an eccentric drive movement into an alternating or reciprocating movement of the displacement piston 2. The roller bearing 32 is a roller bearing lubricated for life, the rolling friction of which between the crankpin 33 and the elongated hole 23 guarantees the introduction of the driving force to the displacement piston 2 over a long term and at high speeds without a subsequent need for lubricant.

The scotch yoke mechanism triggers a reciprocating movement of the displacement piston 2 inside the rectangular pump chamber 10 on an operating path between two dead centres. Due to this functionality, two displacement regions are successively formed in the pump chamber 10 between the displacement surfaces 22 of the displacement piston 2 and the walls of the pump chamber 10 during one rotation of the shaft 3.

As seen in FIG. 2, an inlet pocket 17 is recessed in the chamber wall 11 facing the displacement piston 2 in the region of a mouth of the inlet 15. The inlet pocket 17 has a rectangular outline, the dimensions of which are centred towards the centre of the operating path, and which extends on either side beyond a position respectively taken up by inner or passive displacement surfaces 22 at the dead centres of the displacement piston 2.

In this way, within a time period in which the displacement piston 2 changes directions, the maximally increased volume of a displacement region may be filled with air sucked into the pump chamber 10 by means of a partial vacuum due to the expanding volume via the inlet 12, the inlet pocket 17, and a released gap between the inner or passive displacement surfaces 22 and the assigned outline edge of the inlet pocket 17.

As may be seen in FIG. 3, the displacement piston 2 has two pressure valves 20 that are respectively directed towards one of the two displacement surfaces 22 and are open. The pressure valves 20 correspond to conventional check valves in which a spherical valve body is pre-stressed by a spring against an inlet-side valve seat.

As illustrated in FIG. 5, within the displacement piston 2, the pressure valves 20 are followed by and connected to an outlet channel 21 that essentially forms a connecting line between the two pressure valves 20 and a bore hole arranged vertically thereto arranged towards the chamber wall 11. An opening of this bore hole of the outlet channel 21 carries out the reciprocating movement of the displacement piston 2 with respect to the static chamber wall 11.

In the chamber wall 11, an outlet pocket 12 facing the displacement piston 2 is recessed in the region of the outlet 16. The outlet pocket 12 has a rectangular outline and intersects with the two positions of the opening of the outlet channel 21 which it takes up at the dead centres of the displacement piston 2. By means of its opening, the outlet channel 21 connected behind the pressure valves 20 is always connected to the outlet 16 via the outlet pocket 12 during the entire reciprocal sequence of motions of the displacement piston 2.

In a time period after the filling, the displacement piston 2 moves towards the displacement region of the pump chamber 10 and the air sucked in earlier is compressed. When the compressed air exceeds a set pressure of the pressure valves, an increasingly displaced air volume escapes out of the pump chamber 10 through the corresponding pressure valve 20, the outlet channel 21 and through its opening via the outlet pocket 12 and the outlet 16.

A silencer, not illustrated, including a porous, noise-absorbing material such as foam, for example, is connected to the outlet 16, which reduces a noise level of the pulsation of the displacement processes.

The valve pressure at which the compressed air passes the valve body at the valve seat is set by means of the elastic pretension of the valve body. The valve pressure may essentially be set to the ambient pressure or atmospheric pressure so that the pressure valve only has a barrier effect in a return flow direction and a maximum volumetric efficiency is achieved. The valve pressure may furthermore be selected in connection with the design of the pump geometry, such as, e.g., a negligible remaining clearance volume and a desired operating speed in order to create a small remaining air buffer at the dead centre of the displacement piston 2 which boosts the drive-side power input for overcoming the mass inertia when the displacement piston 2 changes directions.

Frictional forces and frictional losses may thus be reduced to a minimum.

The displacement piston 2 is a cast piece made of sintered metal materials. The four sliding surfaces of the displacement piston 2 which are parallel to the operating path are grinded down to a uniform dimension chosen in order to form a gap seal of less than 50 μm at the piston sliding surface of the pump chamber 10.

The pump housing 1 including four walls of the pump chamber 10 is made as a cast piece or a profile part or sintered part, the inner walls of which are also grinded down to a corresponding dimension of a gap seal in order to form a gap seal in the piston sliding surface of the pump chamber 10. The chamber wall 11, including the ducts for the inlet 15 and the outlet 16, as well as the housing portion 13, which close off the face side of the pump chamber 10 and which form the piston sliding surface, are also manufactured as cast pieces or sintered parts and are set to the dimension of a gap seal by means of a corresponding grinding treatment.

Furthermore, the sliding surfaces as well as the piston sliding surface may also comprise a dynamic, functional surface structure, not illustrated in further detail, which promotes the formation of local air buffers in a micrometre range by means of turbulent swirls. In this way, a laminar air flow in the circumferential gap between the sliding surfaces of the displacement piston 2 and the walls of the pump chamber 10 is disturbed, which improves a dynamic sealing effect of the gap seals as well as a low-friction dry-running capability of the mating surfaces between the displacement piston 2 and the piston sliding surface.

The vacuum pump may also be used as a compressor. When it is used as a compressor, the inlet 15 connected at the vacuum pump to a vacuum line of a system to be evacuated is opened to the atmosphere. When used as a compressor, the outlet 16 opened to the atmosphere at the vacuum pump via the silencer is connected to a pressure line of a pneumatic system or the like.

In an alternative embodiment, the electric motor 4 may be designed as a reluctance motor. In this case, the rotor 43 does not comprise any permanent magnetic elements, but is instead made of a magnetically soft material such as a laminated stack of electrical sheet. Furthermore, the cross-section of such a rotor comprises pole teeth and/or sectors having laminar air gap structures that produce an alternating, magnetic permeability diametrically through the rotor.

1. An oil-free vacuum pump for evacuating gaseous media, comprising:
an electric motor that drives a shaft;
a pump housing with a pump chamber and an inlet and an outlet;
a prismatic displacement piston that, acting bi-directionally and movable over a reciprocal operating path, is accommodated within the pump chamber, the displacement piston releasing a connection between the inlet and the pump chamber in the region of two dead centres of the reciprocal operating path and overlapping in a region lying in between; and
at least one pressure valve that releases a flow of gaseous medium out of the pump chamber through the outlet and blocks a flow into the pump chamber;
wherein the displacement piston has an elongated hole into which a driving force of the shaft is introduced via a crankpin by means of a roller bearing.

2. The oil-free vacuum pump according to claim 1, the at least one pressure valve and at least one outlet channel that establish a connection for the outflow of the gaseous medium between the pump chamber and the outlet of the pump housing being disposed within the displacement piston.

3. The oil-free vacuum pump according to claim 1, the displacement piston being formed in one part as an integral body.

4. The oil-free vacuum pump according to claim 2, two pressure valves, which are respectively assigned to a displacement surface, being disposed within the displacement piston.

5. The oil-free vacuum pump according to claim 1, in the pump housing in the region of the outlet an outlet pocket being formed that faces an opening of the outlet channel within the displacement piston, and the extension of said outlet pocket coinciding with a reciprocal range of movement of the opening of the outlet channel.

6. The oil-free vacuum pump according to claim 1, there being formed in the pump housing in the region of the inlet an inlet pocket that faces the displacement piston and which extends beyond positions of the displacement surfaces that lie inwards at the dead centres of the reciprocal operating path of the displacement piston.

7. The oil-free vacuum pump according to claim 1, the dimensions of the pump chamber and of the sliding surfaces of the prismatic displacement piston that run parallel to the reciprocal operating path forming a gap seal.

8. The oil-free vacuum pump according to claim 7, the dimensions being chosen such that a gap in the pump chamber running round the displacement piston measures less than 50 μm.

9. The oil-free vacuum pump according to claim 1, a noise dampening element being disposed within or at the outlet.

10. The oil-free vacuum pump according to claim 1, the crankpin being connected to a free end of the shaft.

11. The oil-free vacuum pump according to claim 10, the crankpin being connected to the free end of the shaft by means of a rotary plate.

12. The oil-free vacuum pump according to claim 1, a rotor of the electric motor being connected to a free end of the shaft.

13. The oil-free vacuum pump according to claim 11, the shaft being mounted by means of a single shaft bearing having two rows of rolling elements.

14. The oil-free vacuum pump according to claim 13, the electric motor being arranged so as to axially overlap the shaft bearing and a housing portion receiving the shaft bearing.

15. The use of the oil-free vacuum pump as an oil-free compressor that has the features according to claim 1.

16. The oil-free vacuum pump according to claim 12, the shaft being mounted by means of a single shaft bearing having two rows of rolling elements.

17. The oil-free vacuum pump according to claim 16, the electric motor being arranged so as to axially overlap the shaft bearing and a housing portion receiving the shaft bearing.
